(19) United States
(12) Patent Application Publication
(10) Pub. No.: US 2025/0246339 A1
(43) Pub. Date: Jul. 31, 2025

(54) HIGHLY BEND-RESISTANT CABLE HARNESS

(71) Applicant: SAMWON ACT CO., LTD., Busan (KR)

(72) Inventors: Kyung Yul LEE, Bucheon-si (KR); Kwang Jong CHOI, Ansan-si (KR); Eun Yoo CHOI, Suwon-si (KR)

(73) Assignee: SAMWON ACT CO., LTD., Busan (KR)

(21) Appl. No.: 18/573,836

(22) PCT Filed: Jun. 16, 2022
(86) PCT No.: PCT/KR2022/008523

§ 371 Date: Dec. 22, 2023

(30) Foreign Application Priority Data
Jun. 23, 2021 (KR) 10-2021-0081648

(51) Int. Cl. H01B 7/00; H01B 1/02

(52) U.S. Cl. CPC H01B 7/0045; H01B 1/02; H01B 7/0081

(57) ABSTRACT

The present invention provides a configuration as follows. A cable harness comprises: a conductor part; and a sheath part for vertically sheathing the outer circumferential part of the conductor part, wherein in one side of one end part and the other end part of the conductor part, an electrical conductive part is configured at the upper part of the conductor part, and in the other side of one end part of the conductor part, a stiffener is configured at the upper part of the sheath part, and the conductor part has a mesh-type pattern part which repeatedly configures a conductor width and a space part.

### TECHNICAL FIELD

The present invention involves a cable harness used for organizing multiple individual signal lines into a single cable harness. In particular, this also involves increasing the bend-resistance of a cable harness made in the form of a mesh.

### BACKGROUND ART

As shown in FIG. 7, the cable harness (2) is part of an automobile's so-called wiring loom and is installed accordingly. The cable harness (2) comprises multiple individual signal lines (4), which are combined to form one signal bundle (6).

The line bundle (6) is divided into two part-bundles (10) at the junction (8).

Each part-bundle (10) includes multiple signal lines (4) comprising individual signal line cores with insulating sheathing (12).

Some signal line cores are designed here as stranded conductors (14), while others serve as wire conductors (16).

The individual signal lines (4) of the line bundle (6) and the individual signal lines (4) of the two part-bundles (10) are each fastened together within the bundle with the aid of bundling elements (18) consisting of textile-type fiber interlacements.

One of the bundling elements (18a) here is configured as a sheath and has a thickness of 3 mm.

Furthermore, these bundling elements (18a) come together to form the junction (8).

The two part-bundles (10) here are spaced apart in the proximity of the junction (8) by the bundling element (18a). The bundling element (18a) can also be referred to as a sheath (18a) or a branch-type bundling element (18a).

The two part-bundles (10) each also include bundling elements (18a).

The part-bundle (10) with more signal lines (4) has a bundling element (18b).

This bundling element is designed as tape and spirally routed around the perimeter of the part-bundle (10).

The thickness of the tape-type bundling element (18b) here is comparable to the thickness of the adhesive fabric tape and is approximately 0.5 mm.

In contrast, the part-bundle (10) with fewer signal wires (4) includes two bundling elements (18c) (which are designed as a type of tape, and each contains a separate part-bundle (10) in the form of a cable clip).

These bundling elements (18c) here have a thickness of approximately 1 mm.

The bundling element (18b) could also be referred to as a spiral bundling element (18b) or a spiral (18b). The bundling element (18c) could also be referred to as an annular bundling element (18c) or an annular (18c).

An additional bundling element, preferably configured as a type of taping (24), is also schematically illustrated in FIG. 7.

The additional bundling elements are generally configured to absorb greater forces than the textile-type fiber interlacements and are particularly disposed in the stressed areas of the line bundle (6).

For example, in the area where the taping (24) is disposed, the line bundle (6) is subjected to flexural stressing when the line bundle is used as intended.

In the prior art, no description of bend resistance for cable harnesses was presented.

The present invention can be compared to an invention that significantly increases the bend resistance of a cable harness made of a mesh form, which has disadvantages such as being prone to breaking and the greater likelihood of cable disconnections due to frequent bending of the cable harness.

### DETAILED DESCRIPTION OF THE INVENTION

### Technical Problem

The problem to be solved is to improve bend-resistance.

### Technical Solution

To solve the above problem, the present invention incorporates the following configuration.

A cable harness having a sheath covering the outer circumference above and below said conductor part comprises conductor part;

The conductor part comprises a mesh-type pattern part that continuously reconfigures the conductor width and a space part.

At both the ending points of the conductor, an electrically conductive component is attached to the upper portion of the conductor part. At the other side of one ending point of the conductor part, a stiffener is positioned at the upper portion of the sheath.

Said conductor width is at least 10 μm, and said space part is preferably configured to be at most 190 μm to ensure excellent flexibility.

Said conductor width is preferably configured to be a maximum of 190 μm and said space portion is to be a minimum of 10 μm to enhance the electrical conduction capability.

Said sheath is preferably composed of either PEN, PI, or PCT film.

The electrically conductive component is preferably composed of tin.

Said conductor width and said space part of said conductor are each preferably configured to be 100 μm.

Said conductor is preferably configured to have a thickness of 5 μm to 250 μm.

Said sheath is preferably configured to have a thickness of 30 μm to 100 μm.

### Advantageous Effects

The present invention has the effect of significantly increasing bend resistance.

### BRIEF DESCRIPTION OF THE DRAWINGS

FIG. 1 is an overall view of the wire harness.

FIG. 2 shows a longitudinal sectional view of FIG. 1.

FIG. 3A is a view of conducting wire with a mesh pattern.

FIG. 3B is a view of conducting wire with a general pattern.

FIG. 4A is a cross-sectional view of conducting wire with a mesh pattern.

FIG. 4B is a cross-sectional view of conducting wire with a general pattern.

FIG. 5 shows the grip position.

FIG. 6 shows the test criteria of temperature and humidity.

FIG. 7 shows the prior art.

### MODE FOR INVENTION

First, the term “mesh” frequently used in the context of the present invention is defined as:

a mesh net, having any form in which the horizontal and vertical lines intersect and repeat each other.

The present applicant also defines the term “mesh” to be any configuration of repeated shapes, such as diamonds or circles, even if the horizontal and vertical lines do not intersect at right angles.

FIG. 1 is a cross-sectional view in the longitudinal direction, representing a cross-sectional view of a length of 200 mm.

The length is always variable according to the needs of the customer.

FIG. 1 shows a cable harness with a set of six wires.

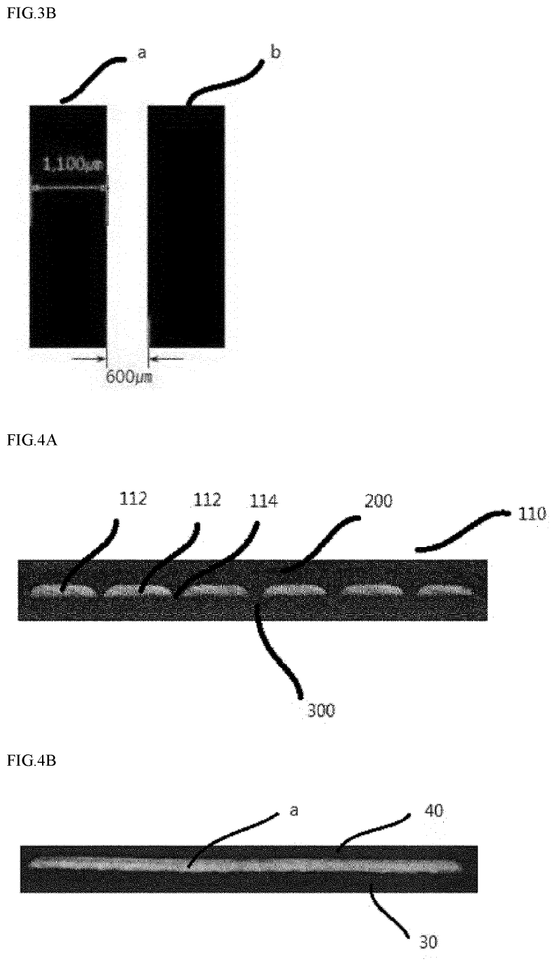

This incorporates the mesh-type pattern in FIG. 3A.

If a 1.1 mm pattern is configured as a mesh type, the 100 μm conductor width is composed of 100 μm of space and consists of six conductor widths of 100 μm, so the total width for one line is 1.1 mm due to the mesh type with five space parts and six conductor widths.

In a 1.1 mm pattern, if the width of the wire is more than 0.1 mm (100 μm) and the space is reduced, the bend resistance will decrease accordingly. If the width of the wire is smaller than 100 μm and the space is increased, the current characteristics of the conductor will decrease.

In the past, when polyimide was used as the coating agent, there was a likelihood of fires occurring due to carbon being generated through carbonization at high temperatures.

Recently, an improved type of PI film has been developed to address the above disadvantages, thereby solving the problem.

Nevertheless, it is possible to apply the present invention to any type of film, such as PI film, because it has superior bend resistance in comparison with existing products.

In the case of using PEN film, there is no risk of fire because the wire only disconnects, thereby preventing secondary large-scale accidents.

However, PEN film has significantly lower bend resistance, so improving the bend resistance of cable harnesses using PEN film has become a pressing issue.

When comparing the regular circuit of PEN film and the mesh circuit of PEN film, the mesh circuit has significantly better bend resistance.

In the case of all the films used in the harness, meshing improves flex resistance, as described above.

PI (Polyimide) has good bend resistance and favorable mechanical properties, but it is highly flammable, as it carbonizes in the event of a fire. Therefore, PEN film was used instead of PI. However, PEN has lower bend resistance than PI, so the mesh circuit was developed to improve its bend resistance.

The present invention improves the bend resistance of all films.

It also solves the problem with using PEN film.

In terms of the thickness of PEN film, if it is too thin, problems may arise. These include issues involving temperature and handling during use. Therefore, in the configuration of the present invention, the film thickness is 50 μm.

In addition, if the thickness of the film is greater than 50 μm, the bend resistance decreases, and the cost increases as the thickness increases.

In the present invention, a tin plating is configured as one embodiment, but various surface treatments such as electroless nickel immersion gold (ENIG) and organic surface prevent (OSP) can be used during Surface Mounter Technology (SMT).

However, this embodiment is based on electroless tin plating, the most common surface treatment used in automotive applications.

The following drawings show the specific configuration.

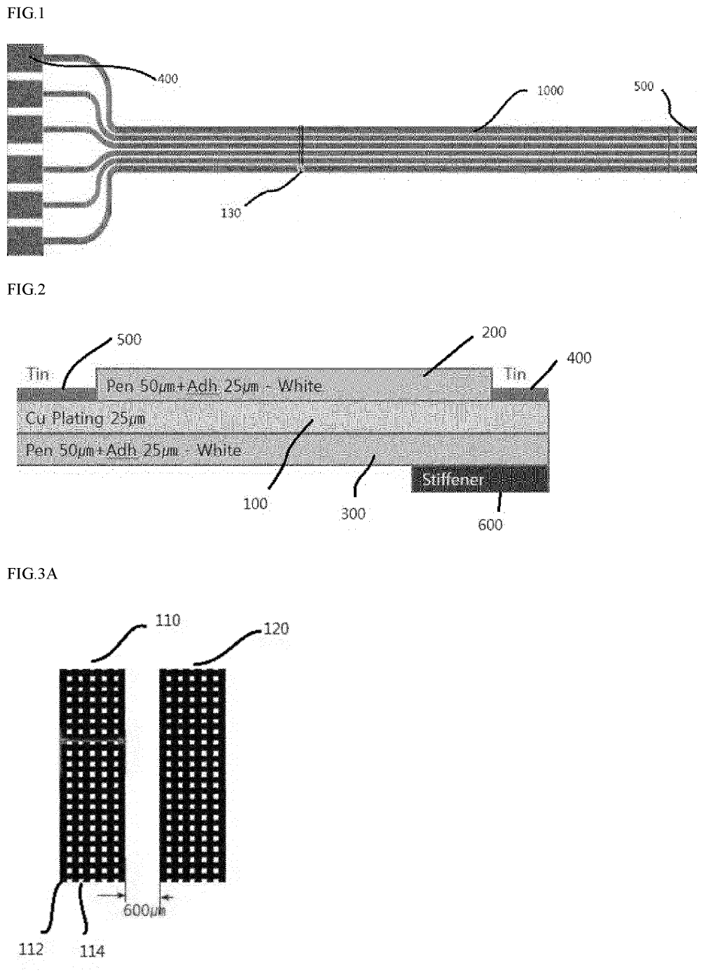

The configuration is described as follows, centering on the drawings of FIGS. 1 and 2.

As shown in FIG. 2, the conductor part (100), copper, is composed of mesh-type pattern parts (110,120).

In FIG. 1 of the present invention, the mesh-type pattern part comprises six circuit lines composing one cable harness.

The configuration made of six conductor parts (100) is referred to as the cable harness (1000) in the embodiment of the present invention.

Depending on demand, the number of circuit lines may be either greater or less than six.

Thus, the mesh-type pattern embodiment illustrated in the drawings of the present invention comprises six circuit lines.

FIG. 3A illustrates the mesh-type pattern parts (110,120) of two circuit lines that are included for the sake of the configuration and spacing of neighboring circuit lines.

After constructing said mesh-type pattern parts (110,120), the sheath (200,300) should cover the outer periphery above and below the conductor of said mesh-type pattern parts.

The thickness of said sheath is preferably configured to be 30 μm-100 μm.

Preferably, said sheath (200,300) is a PEN film. In the prior art, the use of polyimide as a sheath has been characterized by its excellent bend resistance but is vulnerable to fire.

Even when using polyimide with improved fire prevention performance, applying the present invention further improves the bend resistance.

The present invention solves the problem associated with using a PEN film as the sheath, which has advantages in fire protection but significantly poor bend resistance.

Therefore, the present invention constructs a cable harness (1000) in which said conductor (100) comprises a mesh-type pattern part that (110,120) continuously configures the conductor width (112), as well as a space part (114) that improves the bend resistance of the PEN film, thereby improving the bend resistance of the cable harness.

In addition to the PEN film, said sheath may be composed of PI film and PCT film, but the bend resistance may be further improved by applying the present invention.

Reference numeral 130 in FIG. 1 shows the thermistor insertion part (130), which is composed of a single line and has electrically conductive parts at both ends for insertion of a thermistor.

A thermistor refers to a resistor whose resistance changes significantly according to the temperature. It is also called a temperature-sensitive resistor.

In FIG. 3A, where there are six conductor widths (112) and five space widths (114), a single 1.1 mm pattern circuit line is completed because the conductor width and space size are all 100 μm.

The circuit line spacing width, which is the separation distance between the circuit lines, is configured to be 600 μm, but it is variable.

For comparison under the same conditions, the general pattern part (a, b) is also configured with a circuit line width of 1,100 μm, which is a 1.1 mm pattern.

FIGS. 4A and 4B show a cross-section in the width direction of one circuit line in FIGS. 3A and 3B, respectively.

FIG. 4A shows that the conductor width (112) and space part (114) are arranged alternately.

By comparison, the cross-sectional view of the general pattern part (a, b) in the prior art is uniform.

The general pattern part (a, b) also constitutes the sheath (30,40).

In FIG. 3A, a conductor width (112) and space part (114) of uniform size are arranged, whereas in FIG. 4A, which is grown with an actual mold, the conductor width (112) is widened, and the space part (114) is narrowed.

On one side of one end and the other end of said conductor (100), the electrically conductive part (400,500) is configured on the upper part of the conductor (100).

The electrically conductive part is configured at the end of the cable harness so that electrical signals are transmitted through the conductor of the mesh-type pattern part.

The first mesh-type pattern part (110) corresponds to the conductor part (100) adjacent to the second mesh-type pattern part (120).

A general name that pertains to both the first and second mesh-type pattern parts (110,120) is designated the conductor part.

As shown in FIG. 2, the electrically conductive part comprises a first conductive part (400) and a second conductive part (500).

The first conductive part (400) is configured at one end of the conductor, while the second conductive part (500) is configured at the other end.

On the other side of one end of said conductor, a stiffener (600) is configured at the upper part of the sheath (300) to enable a configuration that is capable for insertion of a cable harness.

Said conductor (100) is preferably made of copper.

The conductive parts (400, 500) of both ends of said cable harness may be surface-treated for SMT, such as with tin, gold plating, or OSP.

Said conductor width (112) and said space part (114) of said conductor part (100) are each preferably composed of a mesh type of 100 μm.

The 1.1 mm single-strand pattern is divided into a 100 μm circuit and a 100 μm space in a mesh type.

The circuit width of one strand is made into a mesh by securing space between each circuit line to reduce bending fatigue.

It is predicted that as the conductor width (112) increases and the space part (114) decreases, the bend resistance will decrease.

The thickness of said conductor (100) is preferably 25 μm to 30 μm.

The thickness of cables used in automobiles is generally 25 μm to 35 μm.

The thickness of said PEN film is preferably 50 μm.

The thickness of PEN film used in automobiles is generally 50 μm.

The bend resistance of 50 μm thick PEN film is lower than that of polyimide, so a mesh type was developed to improve the bend resistance.

The conductor width and space width can be adjusted based on a typical circuit.

The conductor width may be a minimum of 10 μm, and the conductor space may be a maximum of 190 μm to increase bend resistance.

Furthermore, the conductor width may be a maximum of 190 μm, and the conductor space may be a minimum of 10 μm to enhance electrical conduction properties.

The thickness of the conductor can range from at least 5 μm to 250 μm.

The above conditions satisfy the criteria for qualifying as an automotive cable harness.

The spacing between the first mesh-type pattern part (110) and the second mesh-type pattern part (120) of the conductor part is configured to be 600 μm.

For fulfilling the same conditions, the spacing between the compared generic pattern parts (a,b) is also configured to be 600 μm.

According to FIG. 5:

When testing bend resistance, a bending test is repeatedly performed by placing a grip at both the first grip position (710) and the second grip position (720) of the cable harness (1000).

In Table 1, three mesh pattern samples (sample 1, sample 2, and sample 3) and three general pattern samples are coated with a 50 μm thick PEN. For adhesion between the covering material and the mesh pattern, the mesh pattern is constructed with an adhesive of 25 μm and a copper conductor thickness of 25 μm.

This configuration allows the three samples to have an average bend resistance of 411times.

The three general pattern samples (sample 5, sample 6, and sample 7) have an average bend resistance of 210 times under the same conditions as the mesh pattern, so the mesh-type pattern has approximately twice the bend resistance bending as the general pattern.

Configuring the conductor part in a mesh pattern in this way improves the weak bend resistance of all films, including PEN films.

TABLE 1

| | | | | Test result of |
|---|---|---|---|---|
| No | TYPE | PEN Film/ADHESIVE | Cu | bending resistance |
| 1 | Mesh | 50/25 | ED 25 um | 415 |
| 2 | pattern | | | 405 |
| 3 | | | | 414 |
| 5 | Normal | 50/25 | ED 25 um | 210 |
| 6 | pattern | | | 209 |
| 7 | | | | 212 |

In Table 1 above, “ED” in “ED 25 μm” stands for electrodeposition, which refers to the electrolytic copper foil.

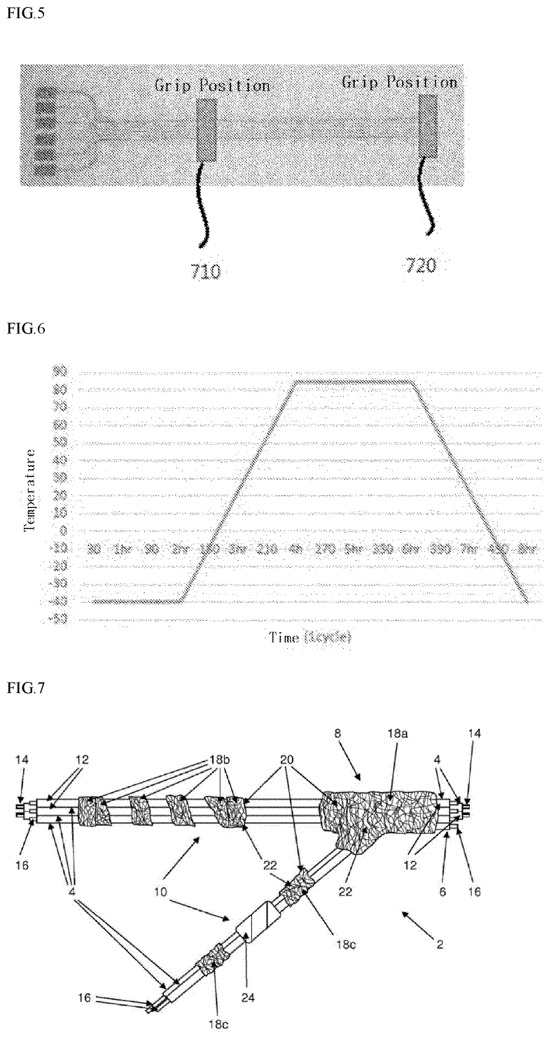

FIG. 6 shows the dry test results of a cable harness manufactured with a general pattern and a cable harness manufactured with a mesh pattern under the following conditions.

As shown in FIG. 6, the temperature/humidity cycle of the cable harness manufactured with a general pattern and a cable harness manufactured with a mesh pattern is as follows.

The temperature is adjusted between −40° C. and 85° C., and the humidity is set at 85%, 1 Cycle/8 Hr, 80 cycles.

Continue for 30 cycles: 2 hours at-40° C., 2 hours with a proportional change from −40°° C. to 85° C., 2 hours at 85°° C., 2 hours with a proportional change from 85° C. to −40° C., for a total of 8 hours in one cycle.

After conducting the temperature/humidity cycle test, an electrical test was conducted to check the OPEN/SHORT of the cable harness manufactured with a general pattern and a cable harness manufactured with a mesh pattern, and both showed excellent results.

Second, the results of the cable harness manufactured with the two patterns in the withstand voltage test were also favorable.

Under the voltage endurance test condition of 2.5 KV, both the cable harness manufactured with a general pattern and a cable harness manufactured with a mesh pattern showed excellent results when the leakage current was less than 1 mA.

The terms or words used in this design specification and claims are not to be construed in their ordinary or dictionary meaning, but should be interpreted in accordance with the meanings and concepts consistent with the technical concept of the present invention, based on the principle that the inventor may properly define the concept of a term to describe his invention best.

Therefore, the embodiments described in this design specification and the configurations illustrated in the drawings are only one of the most preferred embodiments of the present invention and are not intended to represent all of the technical ideas of the present invention. Various substitutions and variations may be used in their place when filing this application.

### INDUSTRIAL APPLICABILITY

The present invention relates to an invention that significantly increases the bend resistance of a cable harness made in the form of a mesh, which commonly breaks or disconnects due to frequent bending of the cable harness and is an invention that has industrial applicability as a technology used in industrial sites such as automobiles.

1. A cable harness having a sheath covering an outer circumference of a conductor part, the cable harness comprising:
the conductor part and wherein the conductor part comprises a mesh-type pattern part that continuously reconfigures a conductor width and a space part.

2. The cable harness of claim 1, wherein, at both ending points of the conductor part, an electrically conductive component is attached to the upper portion of the conductor part and wherein, at the other side of one ending point of the conductor part, a stiffener is positioned at the lower portion of the sheath.

3. The cable harness of claim 1, wherein the conductor width is at least 10 μm, and the space part is at most 190 μm to enhance excellent flexibility.

4. The cable harness of claim 1, wherein the conductor width is a maximum of 190 μm and the space part is a minimum of 10 μm to enhance electrical conduction.

5. The cable harness of claim 1, wherein the sheath is composed of either PEN, PI, or PCT film.

6. The cable harness of claim 2, wherein the electrically conductive component is composed of tin.

7. The cable harness of any claim 1, wherein the conductor width and the space part are each comprised to be 100 μm.

8. The cable harness of claim 1, wherein the conductor has a thickness of 5 μm to 250 μm.

9. The cable harness of any claim 1, wherein the sheath has a thickness of 30 μm to 100 μm.

10. The cable harness of claim 2, wherein the sheath is composed of either PEN, PI, or PCT film.

11. The cable harness of claim 3, wherein the sheath is composed of either PEN, PI, or PCT film.

12. The cable harness of claim 4, wherein the sheath is composed of either PEN, PI, or PCT film.

13. The cable harness of claim 2, wherein the conductor width and the space part are each comprised to be 100 μm.

14. The cable harness of claim 3, wherein the conductor width and the space part are each comprised to be 100 μm.

15. The cable harness of claim 4, wherein the conductor width and the space part are each comprised to be 100 μm.

16. The cable harness of claim 2, wherein the conductor has a thickness of 5 μm to 250 μm.

17. The cable harness of claim 3, wherein the conductor has a thickness of 5 μm to 250 μm.

18. The cable harness of claim 4, wherein the conductor has a thickness of 5 μm to 250 μm.

19. The cable harness of claim 2, wherein the sheath has a thickness of 30 μm to 100 μm.

20. The cable harness of claim 3, wherein the sheath has a thickness of 30 μm to 100 μm.
